(19) United States
(12) Patent Application Publication
(10) Pub. No.: US 2002/0161617 A1
(43) Pub. Date: Oct. 31, 2002

(54) APPARATUS AND METHOD FOR MAINTENANCE BY AN INDIVIDUAL OF DIFFERENT BUSINESS MACHINES

(76) Inventors: JERRY M. WASHBURN, PHOENIX, AZ (US); WILLIAM B MEGER, PHOENIX, AZ (US)

Correspondence Address: TOD R NISSLE P C, P O BOX 55630, PHOENIX, AZ, 85078

(21) Appl. No.: 09/395,071

(22) Filed: Sep. 13, 1999

(51) Int. Cl. G06F 17/60

(52) U.S. Cl. 705/8

(57) ABSTRACT

An improved business machine repair procedure enables a single individual to repair and maintain a plurality of different kinds of business machines owned by a customer.

This invention relates to the repair and maintenance of machines.

More particularly, the invention relates to the repair and maintenance of business machines of the type which are normally utilized or found in a building structure.

In another respect, the invention relates to a method and apparatus which enables a single individual to repair and maintain a plurality of different kinds of business machines owned by a customer.

Presently, the conventional practice appears to be for a business to contract one company to maintenance one kind of business equipment—for example its copy machine—and to contract a second company to maintenance a second kind of business equipment—for example an ATM. When a company maintains only one kind of office equipment, it often is not cost effective to carry out preventative maintenance, or, the company simply does not schedule preventative maintenance and only appears at a customer's place of business when the customer's equipment needs repair. Two prevalent lines of thought have perpetuated the conventional “come only when it needs fixed” practice.

One line of thought is that preventative maintenance is not cost effective and that simply repairing equipment when it breaks is a less expensive procedure for maintaining a piece of equipment.

A second line of thought propounded by so-called industry experts time and time again is that one company or individual cannot offer equipment maintenance across a broad spectrum of equipment types.

The fact remains, however, that the repair and maintenance of business equipment is a cost of doing business, along with the down-time which results when business equipment is broken and can not be operated. In addition, when a repairman who visits a business is familiar only with one particular piece of equipment, the repairman can not assist a customer in maintaining a different piece of equipment also owned by the business.

Accordingly, it would be highly desirable to provide an improved method and apparatus for maintaining and repairing a diverse array of business equipment.

It would also be highly desirable to provide an improved maintenance method and apparatus of the type described which would more efficiently utilize the time of maintenance personnel visiting a business.

Therefore, it is a principal object of the invention to provide an improved method and apparatus for maintenancing business equipment.

Another object of the invention is to provide and improved equipment maintenance method and apparatus which trains an individual to repair a variety of different business machines.

A further object of the invention is to provide documents and computer databases which facilitate, promote, and make efficient preventative maintenance for a variety of different business machines owned by a customer.

Another object of the invention is to provide an improved method for rapidly producing a data base with information concerning each business machine owned by a customer.

Still a further object of the invention is to provide a method and apparatus for correlating necessary preventative maintenance on one machine with a repair call for a different machine owned by a customer.

Yet another object of the invention is to provide a method for maintaining and repairing both OEM business equipment and obsolete business equipment.

These and other, further and more specific objects and advantages of the invention will be apparent to those skilled in the art from the following detailed description thereof, take in conjunction with the drawings, in which:

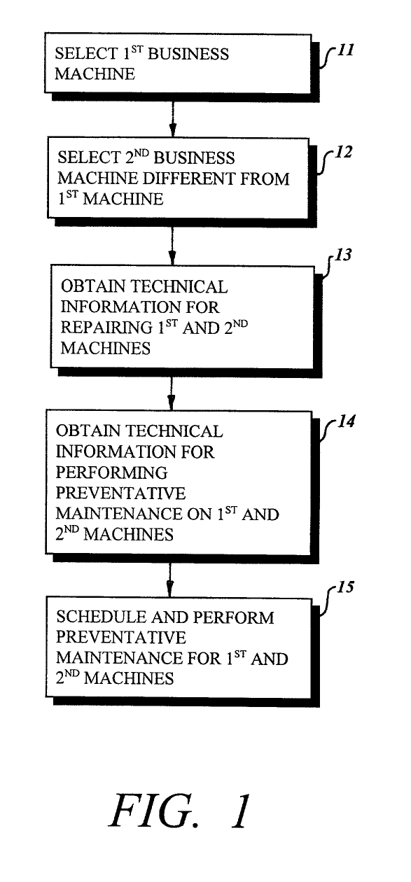

FIG. 1 is a block diagram illustrating a preventative maintenance method in accordance with the invention;

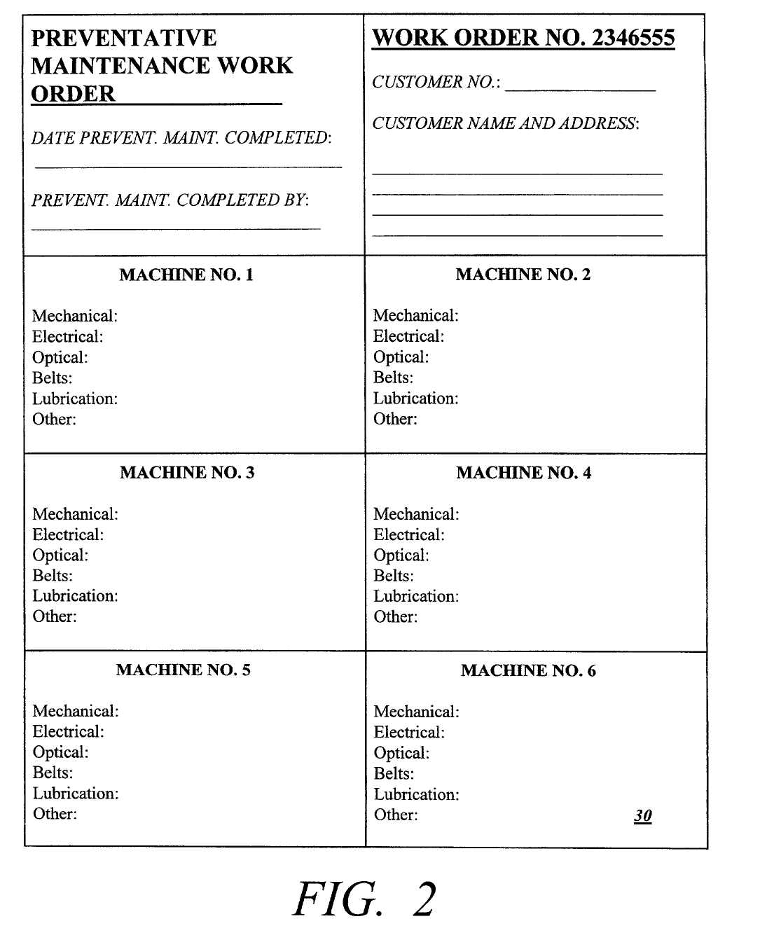

FIG. 2 is an illustration of a business form used to implement preventative maintenance in accordance with the invention;

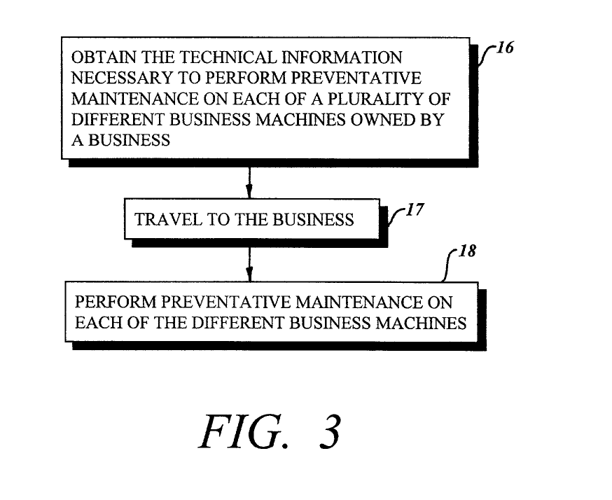

FIG. 3 is a block diagram illustrating a preventative maintenance method in accordance with the invention;

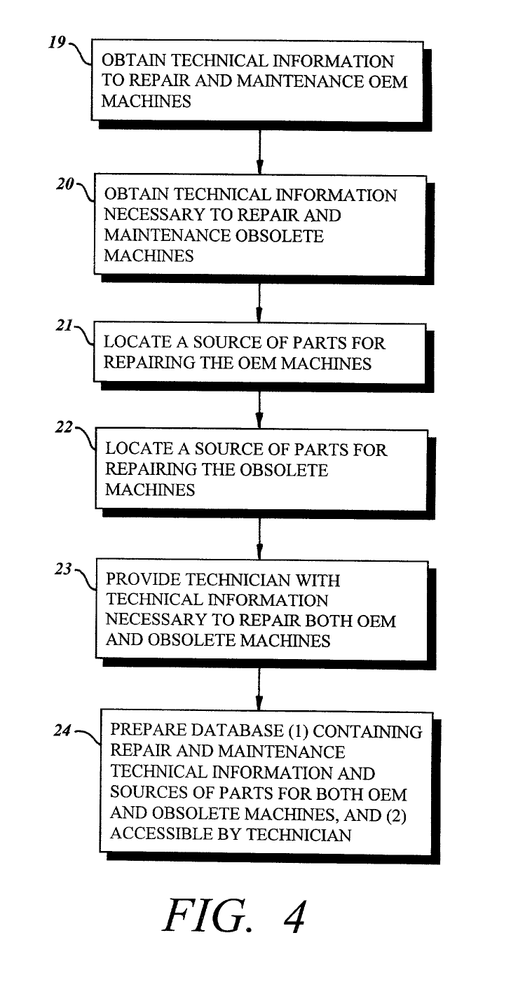

FIG. 4 is a block diagram illustrating a repair and maintenance method in accordance with the invention;

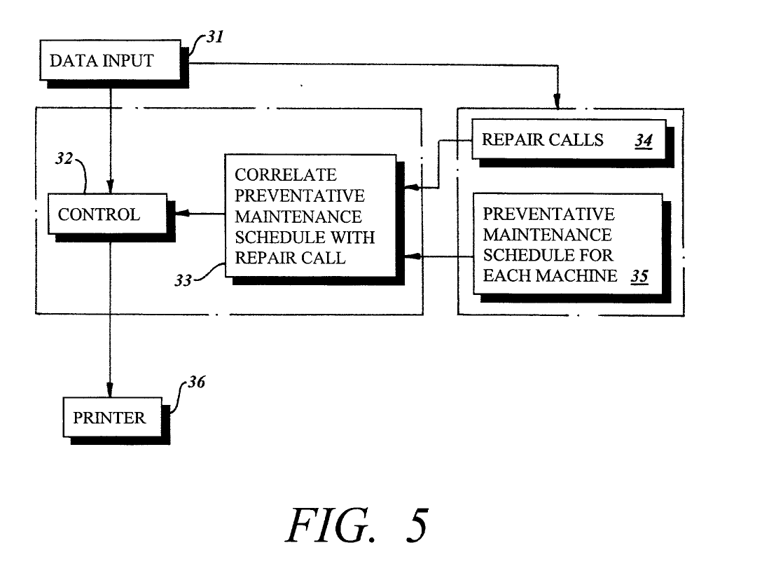

FIG. 5 is a block diagram illustrating a maintenance database constructed in accordance with the invention;

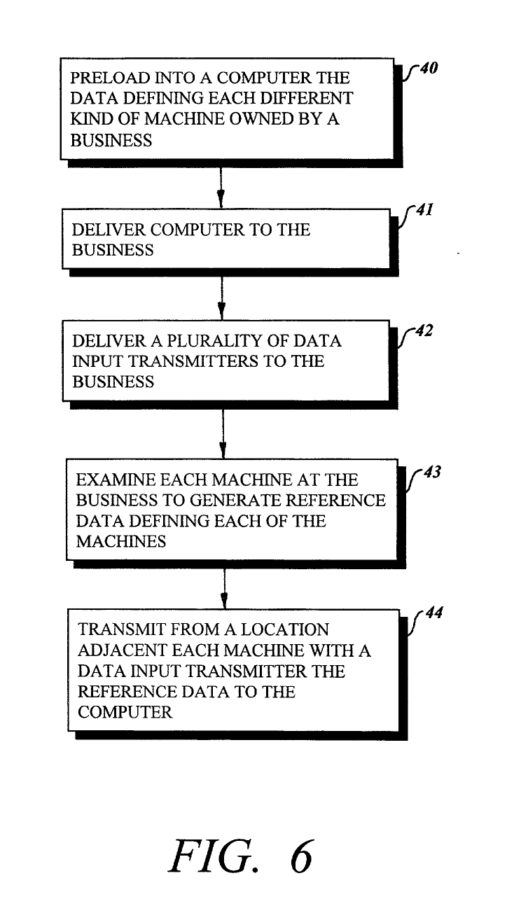

FIG. 6 is a block diagram illustrating a method for rapidly defining on site the business machines owned by a business; and,

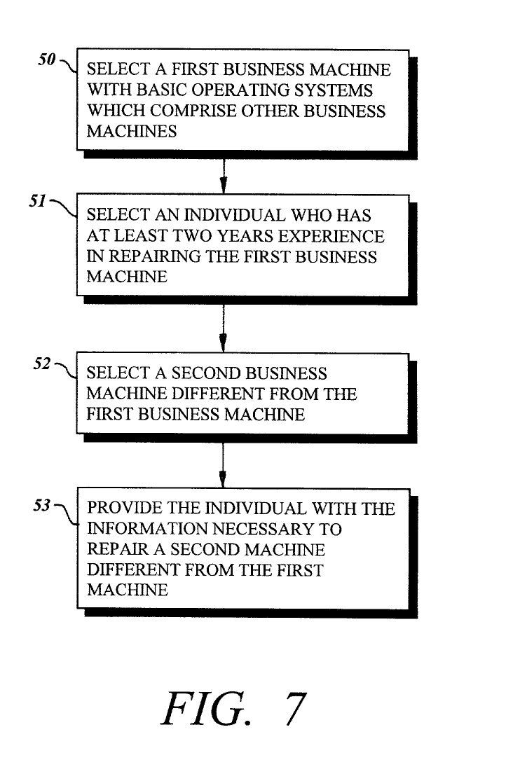

FIG. 7 is a block diagram illustrating a method for performing preventative maintenance on a business machine when another business machine is being repaired.

Briefly, in accordance with our invention, we provide an improved method for maintenancing a plurality of different machines. The method includes the steps of selecting a first business machine; selecting a second business machine different from the first business machine; obtaining the technical information necessary to repair the first and second business machines; obtaining the technical information necessary to perform preventative maintenance on the first and second business machines; and, when necessary to repair the first business machine, performing preventative maintenance on the first and second business machines.

In another embodiment of the invention, we provide an improved work order form. The work order form includes an area for recording data identifying a customer, the customer having a business location at which the customer conducts at least a portion of the customer's business; and, a plurality of areas for recording preventative maintenance carried out on each of a plurality of different kinds of machines at the business location of the customer.

In a further embodiment of the invention, we provide an improved method for maintenancing each of at least three different kinds of business machines at a business. The improved method includes the steps of visiting the business and performing only preventative maintenance on each of the three different kinds of machines; and, recording the preventative maintenance performed on each of the machines.

In still another embodiment of the invention, we provide an improved method for maintenancing machines at a business. The improved method includes the steps of obtaining the technical information necessary to repair and maintenance OEM machines; obtaining the technical information necessary to repair and maintenance obsolete machines; locating a source of parts for repairing the OEM machines; locating a source of parts for repairing the obsolete machines; and, providing to a single technician the technical information necessary to repair both the OEM and obsolete machines. The improved method can also includes the steps of maintaining a computer database of the technical information and source of parts for the OEM machines and obsolete machines; and, utilizing the computer database during the repair and maintenance of the OEM and obsolete machines.

In yet a further embodiment of the invention, we provide a computer database including a computer including a controller and a memory; and, a database in the memory. The database includes a preventative maintenance schedule for each of a plurality of different business machines at a business, the preventative maintenance schedule for each of the machines including at least two separate scheduled times when preventative maintenance is performed; and, includes the specific preventative maintenance required at each of the scheduled times for each of the machines. The database also includes a program or other means for correlating the preventative maintenance schedule for a first of the machines with a call to repair a second of the machines such that when the second of the machines is repaired the specific preventative maintenance for the first of the machines is performed.

In another embodiment of the invention, we provide an improved method for maintaining a plurality of different kinds of business machines at a business. The method including the step of performing a rapid inventory of the different kinds of business machines. The rapid inventory is performed by preloading data into a computer concerning each kind of machine; providing at the business the computer with the preloaded data; providing a plurality of data input transmitters at the business; examining each of the business machines to generate reference data defining each of the machines; transmitting to the computer with one of the data input transmitters from a location adjacent one of the business machines reference data defining the one of the business machines; and, transmitting to the computer with another of the data input transmitters from a location adjacent another of the business machines reference data defining the another of the business machines; and, receiving and entering into the computer the reference data defining the one and the another of the business machines.

In a further embodiment of the invention, we provide an improved method for training an individual to maintenance a plurality of different machines. The improved method comprises the steps of selecting an analog copier; selecting an individual who has at least two years experience in repairing the first business machine; selecting a second business machine different from the first business machine; and, training the individual to repair the second business machine.

Turning now to the drawings, which depict the presently preferred embodiments of the invention for the purpose of illustrating the invention and not by way of limitation of the scope of the invention, and in which like reference characters refer to corresponding elements throughout the several views, FIG. 1 illustrates preventative maintenance method including the steps of “Select 1^{st} Business Machine” 11, “Select 2^{nd} Business Machine Different from 1^{st} Machine” 12; “Obtain Technical Information for Repairing 1^{st} and 2^{nd} Machines” 13; “Obtain Technical Information for Performing Preventative Maintenance on 1^{st} and 2^{nd} Machines” 14; and “Schedule and Perform Preventative Maintenance for 1^{st} and 2^{nd} Machines” 15.

As used herein, a different machine means a machine which is different from a first machine in at least one of four respects. In a first respect, a first machine is different from a second machine if the first machine is a different kind of machine. For example, a typewriter is a different kind of machine than an ATM machine or a copier. In a second respect, a first machine is different from a second machine if the first machine is the same kind of machine but is made by a different manufacturer. For example, a XEROX® copier is the same kind of machine as a CANNON® copier. However, as used herein, a XEROX copier is a different machine than a CANNON copier because it is made by a different manufacturer. In a third respect, a first machine is different from a second machine if the first machine is the same kind of machine as the second machine and is made by the same manufacturer as the second machine, but is a different model than the second machine. For example, XEROX makes several different models of copiers. One XEROX model copier is a different machine than a different XEROX model copier. In a fourth respect, a first machine is different from a second machine if the first machine is the same kind of machine and is made by the same manufacturer as the second machine, but the first machine is an OEM machine still made by a manufacturer while the second machine is obsolete. A machine is obsolete if it is no longer made by a manufacturer.

Obtaining technical information for repairing a machine in accordance with step 13 comprises at a minimum obtaining or preparing schematics, drawings, and/or parts lists, etc. defining the parts in the machine and preferably also includes obtaining schematics which set forth particular systems in a machine like the electrical system, optical system, mechanical system (including motors, gears, belts, levers, etc.).

As used herein, a machine is a device that performs work. A machine produces force and controls the direction and the motion of force. A machine transforms one kind of energy, such as electrical energy, and produces mechanical energy. Some machines like steam turbines, change energy into mechanical motion. All machines have at least one of the following basic systems: an electrical system (electrically conductive wiring, switches, and/or electrical motor or power supply), an electronic system (semiconductors, transistors, resistors, etc.), a mechanical system with moving parts, an optical system, a microprocessor or other computer, a graphics system, a display screen, and a sensor system. A graphics system performs the function of transferring, reading, or scanning images. Copiers (including but not limited to copiers produced by XEROX), printers, fax machines, and scanners each include a graphics system. A sensor system can include mechanical, electrical, optical, laser, or other types of sensors. A display screen can include a computer monitor, a small LED-type display screen on a calculator, or any other screen which (1) displays alphanumeric or other characters or symbols or pictures or things, and (2) enables the alphanumeric characters or other things displayed by the screen to be changed or replaced. Some machines also include a communication system including a telephone or modem or other communication device.

Further, the machines presently addressed herein are primarily business or office machines which are (1) typically found and normally remain at a place of business, (2) utilized in carrying out or recording business transactions or other data or information, and/or (3) are utilized in conjunction with the information or data flow in a business. The information or data flow in a business includes entering data or information, manipulating the data or information, reporting the data or information, printing the data or information, and storing the data or information. Such machines include, for example, copiers (prints data or information), computers (manipulates, stores, reports data or information, and prints information on a printer associated with the computer), typewriters (prints data or information), scanners (enters data or information), printers (prints data or information), ATM machines (inputs data or information from a customer's ATM card and prints data or information on a receipt presented to the customer), coin dispensing machines (inputs data by sensing paper money or credit cards inserted in the machine), calculators (inputs data or information via the calculator keyboard, manipulates the data, and prints the data out on the calculator paper tape or on the calculator display), keyboards (enters data or information), and cash registers (enters information from a keyboard or from a scanner which reads bar codes, and, prints information on a paper tape presented to a customer). Portable computers, calculators, credit verification units, etc. are an exception to this rule and are considered business machines. The method of the invention does not, however, presently pertain to large pieces of equipment or fixtures like airplanes, earth movers, steam shovels, trucks, blast furnaces, smelters, buildings, bridges, etc. which are not reasonably considered to be business or office machines. Such large pieces of equipment or fixtures each typically each have their own unique preventative maintenance schedule. If however, you have a production machine which makes something or performs an operation and has an associated computer which monitors how many items the production machine makes, then the associated computer is considered a business machine because the computer records data and information concerning the operation of the production machine. As those of skill in the art appreciate, however, the methods and apparatus of the invention could be applied to production equipment like lathes, presses, etc. and might well be applied to other types of large equipment. Business machines or office machines maintenanced in accordance with the principles of the invention ordinarily do not include machines powdered by internal combustion engines, but instead utilize electric or electronic motive power means.

Obtaining technical information for performing preventative maintenance on a machine in accordance with step 14 comprises at a minimum obtaining or preparing schematics, drawings, and/or parts lists, etc. which define the preventative maintenance which can be performed on a machine and define the times and intervals at which the preventative maintenance is performed. As used herein, preventative maintenance comprises actions taken on a machine to prolong or improve its operational efficiency when the machine is not broken and is operating normally and performing its intended function. Examples of preventative maintenance include, without limitation, lubricating a machine, checking certain parts for excessive wear which necessitates replacing the parts, replacing parts which are “consumable” and have a limited life during the overall life of the machine, and cleaning a machine. Preventative maintenance is favored in the practice of the invention because proper preventative maintenance tends to reduce the risk that serious damage will occur when a machine breaks, tends to avoid the breakdown of a machine and the cost of having a technician make a special trip to fix the machine, tends to improve the efficiency and effectiveness of the machine, and, tends to avoid a customer encountering lost production time due to the breakdown of the machine. As noted, in practice when a company maintenances only one kind of equipment, preventative maintenance is not cost effective and is not performed because the technician has a schedule to keep and runs from one machine to the next carrying out repairs and not performing preventative maintenance.

In obsolete machines, if technical information can not be located for purposes of repairing and performing preventative maintenance on an obsolete or OEM machine, such information can be generated by examining the machine and preparing a procedure that an individual can follow.

FIG. 2 illustrates a form 30 which is utilized by an individual who is visiting a business to repair a machine or who is visiting the business simply to perform preventative maintenance. In the practice of the invention, when an individual visits a business to repair a first machine, the individual ordinarily is required to perform preventative maintenance on at least one machine other than the machine being prepared. The individual also preferably performs preventative maintenance on the machine being prepared. Further, the individual preferably performs preventative maintenance on at least three machines, most preferably at least five machines, when he visits a place of business to repair a machine or simply to perform preventative maintenance. The preventative maintenance approach of the invention significantly lowers the cost of maintaining business machines, as does the ability to train an individual to repair a variety of different business machines. Form 30 includes a block at the upper left for noting the “Date Preventative Maintenance is Completed” and the name of the individual(s) carrying out the preventative maintenance. A block at the upper right of form 30 includes a space for entering the “Customer No.” and the “Customer Name and Address”. The remaining six blocks on form 30 are for different machines numbers 1 to 6, respectively. In each block, notations can be made concerning the maintenance of mechanical, electrical, optical, belts, lubrication, or other components of the machine.

FIG. 3 describes a maintenance method including a step 16 to obtain the technical information necessary to perform preventative maintenance on each of a plurality of different business machines owned by a business. In step 17, an individual travels to the business; and, in step 18, the individual performs preventative maintenance on each of, or a plurality of, the different business machines owned by the business.

The method of FIG. 4 includes the step 19 “Obtain Technical Information to Repair and Maintenance OEM Machines”; step 20 “Obtain Technical Information Necessary to Repair and Maintenance Obsolete Machines”; step 21 “Locate a Source of Parts for Repairing the OEM Machines”; step 22 “Locate a Source of Parts for Repairing the Obsolete Machines”; step 23 “Provide Technician with Technical Information Necessary to Repair Both OEM and Obsolete Machines”; and, step 24 “Prepare Database (1) Containing Repair and Maintenance Technical Information and Sources of Parts for Both OEM and Obsolete Machines, and (2) Accessible by Technician”.

With respect to step 19, the technical information for repairing and maintenancing OEM machines can typically be obtained from the manufacturer or distributor of the machine. If not, a schedule can be generated by disassembling and examining a machine.

With respect to step 20, the prior art appeared often to have the attitude that obtaining the technical information to repair an obsolete machine was not feasible. However, by contacting past owners of obsolete machines, dealers who stock and sell obsolete machines, and even the company that at one time made the machines, it often is possible to obtain the technical information necessary to repair an obsolete machine. In FIG. 4, as well as in the procedures set forth in FIGS. 1 and 3, the technician ordinarily has the manual or other technical information for an OEM or obsolete machine in advance and prior to traveling to a place of business to repair or perform preventative maintenance on the machine described in the manual.

With respect to step 21 in FIG. 4, parts for an OEM machine can usually be obtained from the manufacturer from companies who make parts for the manufacturer, or from companies who make aftermarket parts.

With respect to step 22, the prior art appeared often to have the attitude that obtaining parts for obsolete machines was not feasible. However, by contacting past owners of obsolete machines, dealers who stock and sell obsolete machines, junkyards, aftermarket parts companies, and even the company that at one time made the machines, it often is possible to obtain the parts necessary to repair an obsolete machine.

Step 24 in FIG. 4 is an important component of the method because entering into a database information concerning how to repair a piece of equipment or components in the equipment, a list of part numbers, the cost of each part, the availability of the part, the time required to obtain the part, etc. greatly facilitates individuals timely repairing a part. Equally important is the storing in the database the various preventative maintenance steps which should be carried out for each different machine and the intervals at which the preventative maintenance steps should be carried out.

The database illustrated in FIG. 5 includes a controller and a memory. The controller includes control 32 and the sub-routine 33 “Correlate Preventative Maintenance Schedule with Repair Call”. The memory includes “Repair Calls” 34 and “Preventative Maintenance Schedule for Each Machine” 35. Data input 31 provides data for the control 32 and the memory. The data input 31 can comprise a keyboard or any other means for entering data. Control 32 directs printer 36 to produce desired documents.

In use, data input 31 is utilized to input the preventative maintenance schedule 35 for each machine owned by a business. Each time a repair call for a particular machine is received, data input 31 enters the date the call is received and the date an individual will be sent to the business to carry out the necessary repair. Each time a date is set for an individual to visit a business to carry out a repair for a machine owned by a business, the sub-routine 33 compares the date the individual will repair the machine with preventative maintenance scheduled for the machine being repaired and for the other machines owned by the business. A set of criteria is utilized by sub-routine 33 is used to determine which machines the individual will perform preventative maintenance on when the individual visits the business to repair the broken machine. By way of example, and not limitation, one such criteria could be that any preventative maintenance scheduled within one month of the date the individual will visit the business and repair the broken machine will be carried out by the individual immediately after the broken machine is repaired. Another criteria could be the estimated time required to carry out preventative maintenance. If the preventative maintenance schedule 35 notes that the preventative maintenance for each of two machines at the business takes two hours and that the preventative maintenance for another machines takes over one day, then sub-routine 33 can include an upper time limit of, for example, three hours for preventative maintenance on any given machine during a trip to repair a machine. Consequently, schedule 35 would schedule the preventative maintenance for the two machines that would take two hours per machine to maintenance but would not schedule the preventative maintenance for the machine which would take over a day to maintenance.

At any rate, after sub-routine 33 determines which additional preventative maintenance tasks are to be carried out when the individual visits a business to repair a machine, sub-routine 33 sends a schedule to control 32. Control 32 directs printer 36 to print a preventative maintenance schedule. The schedule details the particular preventative maintenance to be performed for each machine, along with the estimated time to carry out the preventative maintenance. The schedule is given to the individual who is repairing the broken machine at the particular business. After the individual repairs the machine for which he was called to the business, the individual then performs the preventative maintenance set forth on the schedule printed by printer 36 and makes a record of the preventative maintenance performed on form 30.

The maintenance method of FIG. 7 includes step 50 “Select a First Business Machine with Basic Operating Systems which Comprise Other Business Machines”, step 51 “Select an Individual Who has at Least Two Year Experience in Repairing the First Business Machine”; step 52 “Select a Second Business Machine Different from the First Business Machine”; and, step 53 “Provide the individual with the Information Necessary to Repair a Second Machine Different from the First Machine”.

With respect to step 50, the business machine selected preferably should have the basic operating systems which comprise most or all other business machines. In other words, each business machine includes one or more of said basic operating systems. The basic operating systems are an electrical system (electrically conductive wiring and switches), an electronic system (semiconductors, transistors, resistors, etc.), a mechanical system with moving parts, an optical system, a graphics system, a display screen, a microprocessor or other computer, and a sensor system. Some machines also include a communication system including a telephone or modem or other communication device. The presently preferred business machine selected in step 50 is an analog copier (not a digital copier) because an analog copier includes each of the basic operating machines found in business machine. In fact, the selection in step 50 of an analog copier is presently believed critical in the practice of the method of FIG. 7. An analog copier is believed to be the most difficult business machine to fix. An analog copier includes at the outset each of the basic systems found in most, if not all, business machine. Copiers can also include a communication system including a telephone, modem, etc. An analog copier is believed to be the most difficult machine to maintenance. Copiers are also subjected to higher demand requirements than most or all other machines. Copiers are used and abused and are often critical to the operation of a business.

With respect to step 51, the individual selected has at least two years of experience in repairing the selected business machine, preferably four years of experience, and most preferably five years of experience. The individual selected also preferably has worked for a company, like Xerox or Cannon in the case of copiers, which provides routine training for its maintenance personnel at least once annually. Preferably, the individual selected also believes or can be readily convinced that he or she can “fix any machine”. Some individuals, in large part because of the apparently widespread opinion that maintenancing a variety of different machines is not practically possible and that each maintenance personnel specializes in one particular type of machine, have a mind set which makes it difficult, if not impossible, to train them to repair a variety of different machines, especially where the different machines are different kinds of machines like copiers, typewriters, ATMs, etc.

With respect to step 52, in most cases the second machine is different from the first business machine and is a differed kind of machine. A typewriter is a different kind of machine than a copier. A portable telephone is a different kind of machine than a typewriter. One model of Xerox copier is a different machine than another different model of Xerox copier; however, one model of Xerox copier is not a different kind of machine than another different model of Xerox copier. Both models are copiers and therefore are not different kinds of machines.

With respect to step 53, the individual is trained to repair a plurality of different business machines, preferably a plurality of different kinds of business machines. In the practice of the invention, an individual ordinarily learns to repair at least one model of at least three different kinds of machines (for example, one model Xerox copier, one model of typewriter produced by Cannon, and one model of ATM produced by a particular company). It is most preferred that an individual learn to repair at least one model of five different kinds of machines. Another goal is to teach an individual to repair most or all models of at least two or more (preferably five or more) different kinds of machines. For example, an individual can be taught to repair all or nearly all copiers—regardless of what company makes the copier—and to repair all or nearly all typewriters—regardless of what company makes the typewriters and regardless of whether the typewriters or manual or electric. One way of determining the machines which an individual will learn to repair is to determine if the machines are relatively current models and/or if the machines are still in fairly widespread use. For example, an individual can be taught to repair copiers produced in the last five years but no before because copiers which were produced more than five year ago comprise only a very small part of the market. On the other hand, if equipment has changed little in thirty years or it equipment produced thirty years ago is still utilized by many companies, then an individual may be required to learn how to repair such equipment.

In teaching an individual to maintenance a variety of different machines, it is important to realize that each of the basic operating systems has common key components and operating principles which are common to each iteration of the basic operating system. For example, every electrical system has wires and has switches which permit electricity to flow through the wires and which prevent electricity from flowing through the wires. Each optical system either has an optical lens or has a sensor for “reading” the alphanumeric characters or other data or symbols on a document or other object. Once the key components and operating principles for a basic operating system are understood by a repair and maintenance technician, learning to repair different machines is simplified and becomes a question of learning the construction and parts unique to each particular machine. This is an important advantage of the maintenance system of the invention. It appears inherently to be a more efficient way of maintenancing a group of different kinds of business machines.

Having described our invention in such terms as to enable those skilled in the art to understand and practice it, and having identified the presently preferred embodiments thereof,

We claim:

1. A method for maintenancing a plurality of different machines, said method comprising the steps of
(a) selecting a first business machine;
(b) selecting a second business machine different from said first business machine;
(c) obtaining the technical information necessary to repair said first and second business machines;
(d) obtaining the technical information necessary to perform preventative maintenance on first and second business machines; and,
(e) when said first business machine is repaired, performing preventative maintenance on said first and second business machines.

2. A work order form including
(a) an area for recording data identifying a customer, the customer having a business location at which the customer conducts at least a portion of the customer's business; and,
(b) a plurality of areas for recording preventative maintenance carried out on each of a plurality of different kinds of machines at the business location of the customer.

3. A method for maintenancing each of at least three different kinds of business machines at a business, comprising the steps of
(a) visiting the business and performing only preventative maintenance on each of said different kinds of machines; and,
(b) recording the preventative maintenance performed on each of said machines.

4. A method for maintenancing machines at a business, including the steps of
(a) obtaining the technical information necessary to repair and maintenance OEM machines;
(b) obtaining the technical information necessary to repair and maintenance obsolete machines;
(c) locating a source of parts for repairing said OEM machines;
(d) locating a source of part for repairing said obsolete machines;
(e) providing to a single technician the technical information necessary to repair both said OEM and obsolete machines.

5. The method of claim 4 including the steps of
(a) maintaining a computer database of said technical information and source of parts for said OEM machines and obsolete machines; and,
(b) utilizing said computer database during the repair and maintenance of said OEM and obsolete machines.

6. A computer database including
(a) a computer including a controller and a memory;
(b) a database in said memory including
(i) a preventative maintenance schedule for each of a plurality of different business machines at a business, said preventative maintenance schedule for each of said machines including at least two separate scheduled times when preventative maintenance is performed, and
(ii) the specific preventative maintenance required at each of said scheduled times for each of said machines; and,
(c) means for correlating said preventative maintenance schedule for one of said machines with a call to repair another of said machines such that when said another of said machines is repaired the specific preventative maintenance for said one of said machines is performed.

7. A method for maintaining a plurality of different kinds of business machines at a business, said method including the steps of
(a) performing a rapid inventory of said different kinds of business machines by
(i) preloading into a computer data concerning each kind of machine,
(ii) providing at the business said computer with said preloaded data,
(iii) providing a plurality of data input transmitters at the business,
(iv) examining each of said business machines to generate reference data defining each of said machines,
(v) transmitting to said computer with one of said data input transmitters from a location adjacent one of said business machines reference data defining said one of said business machines, and
(vi) transmitting to said computer with another of said data input transmitters from a location adjacent another of said business machines reference data defining said another of said business machines; and,
(b) receiving and entering into said computer the reference data defining said one and said another of said business machines.

8. A method for training to maintenance a plurality of different machines, said method comprising the steps of
(a) selecting an analog copier, said copier including
(i) at least one electrical system,
(ii) at least one electronic system,
(iii) at least one mechanical system with moving parts,
(iv) an optical system,
(v) a computer,
(vi) a sensor system,
(vii) a graphics system, and
(viii) a display screen;
(b) selecting an individual who has at least two years experience in repairing said copier;
(c) selecting a second business machine different from the first business machine; and,
(d) training the individual to repair said second business machine.
